(19) United States
(12) Patent Application Publication
(10) Pub. No.: US 2008/0113599 A1
(43) Pub. Date: May 15, 2008

(54) SAFETY WORKBENCH WITH BLOWER PERFORMANCE CONTROLLABLE DEPENDENT ON THE POSITION OF THE FRONT PANE

(75) Inventors: Gerd Ross, Frankfurt (DE); Hermann Stahl, Nidderau-Ostheim (DE); Heiko Reinhardt, Alzenau (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THERMO ELECTRON LED GMBH

(21) Appl. No.: 11/938,027

(22) Filed: Nov. 9, 2007

(30) Foreign Application Priority Data
Nov. 10, 2006 (DE) DE102006053122.1

(51) Int. Cl. B08B 15/02; F24F 7/007

(52) U.S. Cl. 454/61; 454/66

(57) ABSTRACT

A safety workbench includes a work chamber enclosed by a housing, including a work opening located in the housing front side and settable using an adjustable front pane to let in an external air flow flowing into the work chamber, and including at least one fan for delivering the external air flow into the safety workbench. To improve the working conditions of the safety workbench for operators while simultaneously ensuring sufficient personal protection at all times, a regulating unit and/or a control unit is provided, by which the delivery output of the at least one fan can be regulated and/or controlled as a function of the front pane position.

### TECHNICAL FIELD

The present invention relates to a safety workbench having a work chamber enclosed by a housing, having a work opening, located in the housing front side and settable using an adjustable front pane, for letting in an external air flow flowing into the work chamber, and having at least one fan for conveying the external air flow into the safety workbench.

### BACKGROUND OF THE DISCLOSURE

The present invention relates to a safety workbench having a work chamber enclosed by a housing, having a work opening, located in the housing front side and settable using an adjustable front pane, for letting in an external air flow flowing into the work chamber, and having at least one fan for conveying the external air flow into the safety workbench. The present invention relates to a safety workbench having a work chamber enclosed by a housing, having a work opening, located in the housing front side and settable using an adjustable front pane, for letting in an external air flow flowing into the work chamber, and having at least one fan for conveying the external air flow into the safety workbench.

Safety workbenches of this type, and in particular those for processing microbiological samples, as are described in DE 44 41 784 C2 and DE 100 17 196 A1, for example, protect from contamination by bioaerosols, which arise and are released during microbiological work. The air flows contaminated by bioaerosols are continued as directed air flows with the aid of fans inside the safety workbenches and conducted via filters which retain the contaminant from the air flow. These filters are high-performance suspended matter filters, such as HOSCH or HEPA filters, which are capable of filtering out the microorganisms present in the air flow. At least a part of the air thus filtered is exhausted as the exhaust air flow from the safety workbench and introduced into the ambient air of the safety workbench.

Safety workbenches differ in their safety precautions and are constructed, tested, and licensed in accordance with the various international norms. Safety workbenches are divided into classes I, II, and III as a function of their mode of operation, safety workbenches of class I offering personal protection and safety workbenches of classes II and III also offering product protection in addition to the personal protection.

In safety workbenches of classes I and II, the personal protection is achieved in that external air is suctioned uninterruptedly into the work chamber through the work opening. As long as this external air flow is not obstructed and sufficient air is taken in, particles and aerosols cannot reach the outside from the inner chamber of the safety workbench. The external air suctioned in thus forms an air curtain flowing through the work opening, which protects the individuals working at the safety workbench and/or the environment from contamination by particles and similar material. In safety workbenches of class III, the personal protection is ensured by closing the work opening using a rubber or plastic curtain, in which gripping openings, which are similar to gloves and are closed toward the work chamber, are located. The present invention relates to safety workbenches of classes I and II.

The protection for work objects in the workbench from external contamination or from contamination by other samples located in the workbench (cross-contamination), which is additionally provided by safety workbenches of classes II and III, is achieved in that a part of the air flow sucked into the workbench is fed back to the inner chamber as a circulating air flow after filtering. The circulating air flow is oriented for product protection in such a way that it washes around the objects located in the workbench and thus prevents contaminated air from coming into contact with these objects.

Adequate personal protection is a requirement for the operation of safety workbenches. This property of the safety workbench, which is also referred to as retention capability, is defined, for example, by the air entry velocity of the external air flow in the area of the work opening. For example, minimum limiting values for the air entry velocity are prescribed in DIN EN 12469, which must be maintained to ensure sufficient personal protection at all times.

The front panes are generally implemented as adjustable in height parallel to the work opening. The height of the work opening is thus variably settable, which in turn has a direct influence on the air entry velocity of the external air flow. With increasing height of the work opening, the air entry velocity of the air flow decreases proportionally and vice versa. Therefore, it is typical to predefine the delivery output of the fan conveying the external air flow as fixed in such a way that even at maximum height of the work opening, the air entry velocity of the external air flow has a value which is above the prescribed minimum value. Personal protection is thus ensured at all times. Lower delivery outputs would endanger the safety of the operators. An adjustment of the fan of this type, on the other hand, has the result that the noise and heat emissions of the safety workbench are relatively high. In addition, vibration may occur during operation. This is undesirable from an ergonomic viewpoint and worsens the working conditions of operators when working with the safety workbench. Furthermore, the occurring vibrations may have an undesired, negative influence on the microbiological samples located in the safety workbench.

### SUMMARY OF THE DISCLOSURE

Therefore, it is the object of the present invention to specify a safety workbench in which the working conditions are improved for operators and adequate personal protection is simultaneously ensured at all times.

This object is achieved in that a safety workbench of the type cited at the beginning has a regulating unit and/or a control unit, by which the delivery output of at least one fan may be regulated and/or controlled as a function of the front pane position. Preferred embodiments may be inferred from the subclaims.

By the ability to regulate and/or control the at least one fan, it is possible to tailor its output to the height of the work opening because of the situation. For example, if the front pane is raised from a specific position during operation, i.e., the height of the work opening is increased, the control unit controls the at least one fan in such a way that its delivery output is increased. Vice versa, in the event of a reduction of the work opening height, the fan output is reduced. If a regulating unit is used, the delivery output is regulated in such a way that the air entry velocity, even in the event of changing work opening height, continuously corresponds to a predefined setpoint value and/or setpoint value range. By increasing/reducing the fan output, the reduction/increase of the air entry velocity of the external air flow, caused by an enlarged/reduced work opening, may be compensated for, so that sufficient personal protection is continuously ensured. Fundamentally, only the regulating unit or the control unit or both units together may be used in the safety workbench according to the present invention. An integrated implementation of the regulating and control units is also possible.

It is advantageous in the present invention that the delivery output of the at least one fan is adaptable to the size of the work opening in such a way that only the delivery output required for sufficient personal protection is achieved. For example, if a work object is to be inserted into the safety workbench, the work opening is generally opened relatively wide, so that an operator may introduce the object into the safety workbench unobstructed. The regulating unit or the control unit correspondingly regulates or controls the at least one fan in such a way that a relatively high delivery output is achieved. If an operator has to perform work on this work object after introducing the object into the safety workbench, the relatively large work opening height is no longer necessary and the front pane may be lowered to a lower position, by which the work opening is reduced. Correspondingly, the delivery output of the fan is decreased by the regulating unit or the control unit. The noise and heat emissions of the safety workbench are thus reduced for the operator during work, and the danger of possible vibration of the safety workbench and/or the work object located therein is reduced. The working conditions for the person operating the safety workbench are thus improved by the present invention, while simultaneously ensuring the personal protection.

Fundamentally, the safety workbench, according to the present invention, may have one or more fans. It is preferable for at least those fans which have an influence on the external air flow, i.e., suction external air through the work opening into the work chamber, to be able to be regulated and/or controlled by the regulating unit and/or the control unit. The ability to regulate and/or control the delivery output of the at least one fan is generally achieved in that the regulating unit and/or the control unit regulates the supply voltage of the at least one fan, by which the delivery output is adaptable to the particular front pane position. The at least one fan may be both an alternating current fan and also a direct current fan.

The regulating unit and/or the control unit expediently regulates or controls the at least one fan in such a way that the air entry velocity of the external air flow, independently of the front pane position, is always set to a value which is in the range of ±5%, especially preferably ±2%, of a previously determined value for the air entry velocity. An approximately constant value thus results for the air entry velocity. The previously determined value for the air entry velocity is to be selected in such a way that the minimum value of the value range resulting therefrom is equal to or greater than the minimum value for the air entry velocity required by the norms for safety workbenches. Predefining such a value corridor, in which the air entry velocity of the external air flow may lie, is expedient, because there may be time delays of the adaptation of the fan output in the event of changes of the front pane position, so that small deviations from the predefined value for the air entry velocity are possible. Furthermore, in the event of only slight changes of the front pane position, a change of the delivery output may be dispensed with under certain circumstances, if the new value to be set for the air entry velocity is still in the permissible value corridor at identical fan output. Certain defined deviations and variations of the delivery output of the at least one fan are thus possible in the safety workbench according to the present invention. These deviations are preferably to be kept as small as possible, however, to ensure optimum operation of the safety workbench.

To ensure that the air entry velocity is kept constant and/or within a predefined value range, it is expedient for the safety workbench to have a flow sensor for measuring the air entry velocity of the external air flow in the area of the work opening. The flow sensor is preferably situated in the flow direction behind the work opening. Furthermore, it is expedient to situate a further flow sensor in the area of the exhaust air flow, which is led out of the safety workbench. The flow sensor is advantageously situated in the flow direction behind the exhaust air filter. For example, if the throughput of a filter is reduced by contamination, this may be established by measuring the flow value of the exhaust air flow and the fan output may be adapted accordingly. In this way, the safety of the safety workbench is increased further. The positioning of the flow sensors to ascertain the flow values of the air entry and the exhaust air velocities is not particularly restricted, but is to be performed in such a way that interfering influences which corrupt the measurement result are avoided as much as possible. The measurement results of the flow sensors are preferably relayed at predefined time intervals to the regulating and/or control units and analyzed therein.

To be able to set the delivery output of the fan in such a way that it is ensured in any arbitrary front pane position that the air entry velocity of the external air flow is constant and/or lies within a predefined value range and adequate personal protection thus results continuously, it is expedient to store an air entry velocity setpoint value in the regulating unit. Fundamentally, the setpoint value may also be a value range. The regulating unit evaluates the data measured by the flow sensor for the air entry velocity and regulates the delivery output of the fan in such a way that the measured values of the air entry velocity essentially correspond to the setpoint value. As already noted above, the setpoint value sometimes only approximately results for the actual value, and the above-mentioned value ranges may be predefined, in which the actual value must lie. To increase the safety of the safety workbench, the regulating unit may be implemented to incorporate further parameters in the regulation of the fan. In addition to the air entry velocity setpoint value, an exhaust air velocity setpoint value is preferably also stored in the regulating unit. In this way, for example, in the event of clogging of the filter, the delivery output of the fan may be regulated to a value at which a sufficient exhaust air quantity may be exhausted from the safety workbench. The regulation itself is performed similarly to the regulation of the air entry velocity. Fundamentally, still further parameters may be considered in the regulation. In this way, in addition to the work opening height, further influencing variables on the air entry velocity (e.g., a degree of contamination of the filter, air resistances in the exhaust air line) may also be detected and compensated for.

The safety workbench advantageously has a position sensor for measuring the front pane position. This position sensor may, for example, be situated directly on the lower edge of the front pane and may indicate the position of the front pane edge in its guide means via electrical contacts. However, other suitable measuring units are also usable. Measuring units of this type are fundamentally known in the prior art and do not have to be explained in greater detail here. The exact position of the front pane may be determined by the presence of a position sensor of this type, and the control unit may control the at least one fan optimally. Fundamentally, the position ascertainment of the front pane may occur continuously or discretely, i.e., at intervals, a continuous measurement being preferred because of the higher precision. Alternatively to measuring the front pane position, the height of the work opening may also be measured using a corresponding sensor. Values for the work opening areas as a function of the front pane position are expediently stored in the control unit, so that the control unit may assign a specific work opening area to a particular front pane position. The work opening area, which has an influence on the air entry velocity, may thus be determined at any time.

To be able to adapt the delivery output of the at least one fan to the particular measured front pane position, it is expedient for previously determined delivery output values for the at least one fan to be stored in the control unit. Every delivery output value is assigned to one front pane position. The control unit assigns the measured front pane position to the particular corresponding delivery output value and controls the at least one fan in such a way that the delivery output of the at least one fan essentially adjusts to the assigned delivery output value. It is preferable for the control unit to control the delivery output of the fan in such a way that the actual delivery output value results in a value corridor of, for example, ±5%, especially preferably ±2%, from the previously determined delivery output value. The stored delivery output values are expediently selected in such a way that the air entry velocity of the safety workbench remains approximately constant independently of the front pane position. Setting such value corridors is expedient, because slight deviations may occur due to a time-delayed adaptation of the delivery output, for example. The value corridors are to be selected in such a way that adequate personal protection is provided at all times. Fundamentally, arbitrarily many delivery output values for arbitrarily many front pane positions may be stored in the control unit. The intervals between the individual front pane positions are also selectable arbitrarily. At least the delivery output values for those front pane positions which are used in practice by operators, and/or are actually settable on the safety workbench, are expediently stored.

Alternatively or additionally, a formula may be stored in the control unit, using which an optimal delivery output value may be ascertained by the control unit for every front pane position. The control unit controls the at least one fan in such a way that a delivery output results which corresponds to the ascertained delivery output value. It is also preferable here to set the actual delivery output to a value in the range of a value corridor of ±5%, especially preferably ±2%, around the ascertained delivery output value. It is advantageous with the use of a formula of this type for a delivery output value to be able to be ascertained for every possible front pane position. The formula expediently comprises the parameters of air entry velocity, work opening area, and fan output, the air entry velocity being constant and the two other dimensions being variable. The work opening area is ascertained by measuring the front pane position, so that the fan output required for keeping the air entry velocity constant may then be calculated. To further improve the safety of the safety workbench, it is expedient, in addition to controlling the delivery output as a function of the work opening area, to regulate the delivery output on the basis of further influencing variables, for example, the existing exhaust air velocity. In this way, all influencing variables acting on the air entry velocity may be considered and compensated for.

To store the previously determined setpoint values, delivery output values, and/or a formula, it is expedient for the regulating unit and/or control unit to have at least one storage medium. Furthermore, it is expedient for the regulating unit and/or the control unit to comprise a processor, using which the required computing operations for comparing the setpoint and actual values, for comparing the transmitted measured values to the stored values, and/or for calculating the delivery output values are executable. Fundamentally, it is also possible for the regulating unit and the control unit to access a shared storage medium.

In order that the setpoint values, delivery output values, and/or the formula for ascertaining the delivery output may be input into the storage medium when the safety workbench is first put into operation and/or in the event of maintenance work, it is expedient for the safety workbench to have a terminal and/or an interface, through which a corresponding input may be performed. The safety workbench may be connected to a central administration system via the interface, for example, so that the values may be input spatially separate from the safety workbench. This is particularly advantageous if multiple safety workbenches must be maintained and/or first put into operation simultaneously.

Fundamentally, it is possible to implement the safety workbench in such a way that the front pane is manually adjustable by an operator. However, it is preferable for the front pane to be automatically movable with the aid of suitable means. For this purpose, for example, an electric motor having a corresponding device for moving the front pane is suitable. It is expedient for buttons or switches to be provided on the safety workbench, using which the front pane may be adjusted by an operator. The means for adjusting the front pane are activated via the buttons or switches. It is also possible for the front pane to be adjustable using a remote control. Fundamentally, the front pane may be adjusted continuously, so that operators may adapt the height of the work opening to the existing working conditions individually. It is expedient in this case that if a control unit is used, it ascertains the delivery output values for the at least one fan using a formula stored in the storage medium, because a value may be calculated for any arbitrary pane position using the formula. In regard to the safety norms to be maintained and the required computing effort, however, it is preferable for the front pane to be adjustable in steps between various predefined positions. The front pane is especially preferably adjustable between a first and a second work position. Of course, the front pane may also be brought into a closed position in addition to the two work positions, in which the work opening is entirely closed. In this embodiment, the front pane is only settable to a few specific positions, which are selected in such a way that all work to be performed in the workbench is executable, but it is simultaneously ensured that all operating parameters which are necessary for a safe work process are maintained. In this embodiment, if a control unit is used, the delivery output of the fan is expediently determined by the control unit via previously determined delivery output values, which are assigned to the particular predefined work positions, because in this way the required processor performance may be reduced.

The first work position is expediently selected in such a way that the height of the work opening is relatively low, but still leaves enough freedom of movement for an operator, who inserts his arms to the work opening into the workbench to perform work on work objects located therein. The work opening preferably has a height of 10 to 20 cm (centimeters), especially preferably 13 to 17 cm, in the first work position. Heights in these ranges offer sufficient movement freedom to operators. Simultaneously, the size of the work opening is reduced to the required minimum, by which the delivery output of the fan may be reduced by the control unit and/or the regulating unit and the noise and heat emissions of the safety workbench may thus be decreased. The first work position is preferably also selected in such a way that the mean noise level of the safety workbench during operation is in a range from 50 to 55 dB (decibel), especially preferably 52 to 53 dB. This results in improved working conditions for the operators.

The second work position is expediently selected in such a way that there is sufficient space to insert and/or remove work objects to and from the safety workbench. The work opening preferably has a height of 30 to 40 cm, especially preferably 33 to 37 cm in the second work position. The work opening thus has sufficient space so that nearly all work objects normally introduced into safety workbenches may be introduced safely and comfortably by operators into the safety workbench and/or removed therefrom. After inserting and/or removing the work objects, the front pane is brought back into the first work position, and the work on the work objects may be executed in working conditions which are improved for the operators.

In a further preferred embodiment of the present invention, the safety workbench is implemented in such a way that the front pane is only movable between specific positions as a function of the operating state of the safety workbench. The operating state in which the safety workbench is currently located may be established in monitoring and feedback devices, which are known per se and are typically provided in a safety workbench, which communicate to a control unit, for example, whether the workbench is turned on or off, light, ventilation, and sockets of the device are turned on or off, a malfunction state exists or not, etc. The positions into which the front pane is to be movable in a particular operating state are expediently stored in the storage medium of the control unit and/or the regulating unit. It is advantageous that due to these position presets, the front pane is always only located in the optimal positions for the particular existing operating state. If the workbench is in a malfunction state, for example, and this is communicated to the control unit and/or the regulating unit, it may be predefined that in this operating state the front pane is only movable into the closed position or only into a relatively low work position, because it is not ensured as a result of the malfunction that sufficient personal protection is guaranteed in the event of a large work opening height. The safety of the workbench is thus further improved.

To further improve the safety of the safety workbench according to the present invention, it is expedient for the safety workbench to output a visual and/or acoustic alarm if the measured height of the work opening exceeds a previously determined maximum value. This may be advantageous, for example, if the maximum delivery output of the at least one fan only permits a maximum height of the work opening while maintaining personal protection and personal protection may no longer be ensured in the event of a height exceeding this maximum value. Furthermore, in safety workbenches of class II, too great a height of the work opening may endanger maintaining the circulating air circulation and thus the product protection. Multiple, different maximum values may also be predefined as a function of the particular operating state of the safety workbench.

Furthermore, it is expedient for the workbench to have at least one measuring device, which ascertains the power consumption and/or the speed of the at least one fan. The measurement results of the flow sensors present in the safety workbench and of the measuring device are relayed at predefined time intervals to a safety monitoring system and analyzed therein. For this purpose, value ranges are stored in a storage medium of the security monitoring system, which specify within which limits the air entry velocity of the external airflow and the power consumption or the speed of the at least one fan are to lie. Instead of implementing a storage medium in the safety monitoring system, it may also be implemented to access a storage medium of the regulating or control unit. In general, the safety monitoring system may also be implemented as integrated in one of the two units. If the safety monitoring system determines a deviation of the measured parameter from the predefined ranges, an acoustic and/or visual alarm is expediently output. It is also possible for the safety monitoring system to cause further suitable measures, such as the closing of the work opening, for example, in case of a malfunction. The control unit and/or the regulating unit and the safety monitoring system may be implemented integrated as one component or separately. The components expediently have a mutual communication link for the purpose of data exchange.

Furthermore, it is expedient for the regulating unit and/or the control unit to be programmed in such a way that the at least one fan may only be operated within the stored value ranges for the power consumption and/or the speed. This may effectively prevent the at least one fan from being damaged by too high a power supply or too a high speed. If operation is not possible under the predefined conditions, the safety monitoring system of the workbench triggers an acoustic and/or visual alarm. In addition, as in all other alarm cases as well, the causes for the originating alarm may be displayed on a display or in another suitable way.

The safety monitoring system of the safety workbench expediently additionally has units for monitoring the functional capability of essential components of the safety workbench. In addition to maintaining predefined operating parameters, it is thus monitored whether specific components of the safety workbench are ready for operation at all. At least one of the components of position sensor, flow sensor, measuring device, fan, and power supply of the safety workbench is preferably monitored by the safety monitoring system. To ensure safe operation of the workbench, multiple or all of these components are expediently monitored regularly for their undisturbed operational capability. If a breakdown or defect of even only one of the monitored components is noted, a visual and/or acoustic alarm is output. Above all, the monitoring of the control unit and/or the regulating unit by an independent safety monitoring system is advantageous, because it is thus ensured that the delivery outputs of the at least one fan regulated or controlled by the regulating unit and/or control unit correspond to the presets and adequate personal protection is guaranteed.

The multiple checks of the essential components and operating parameters of the safety workbench allow the guidelines according to DIN EN 12469 to be maintained especially reliably. The sensors used for the monitoring are known per se and therefore do not have to be explained in greater detail.

The present invention is explained in greater detail on the basis of a drawing in the following.

### BRIEF DESCRIPTION OF THE DRAWINGS

FIG. 1 schematically shows a safety workbench having a front pane in a first work position;

FIG. 2 schematically shows the safety workbench from FIG. 1 having the front pane in the second work position;

FIG. 3 schematically shows a cross-section of the safety workbench shown in FIG. 1;

FIG. 4 schematically shows a cross-section of the safety workbench shown in FIG. 2;

FIG. 5 schematically shows a circuit diagram of a safety workbench having control unit and safety monitoring system, and

FIG. 6 schematically shows a circuit diagram of a safety workbench having regulating unit and safety monitoring system.

### DETAILED DESCRIPTION

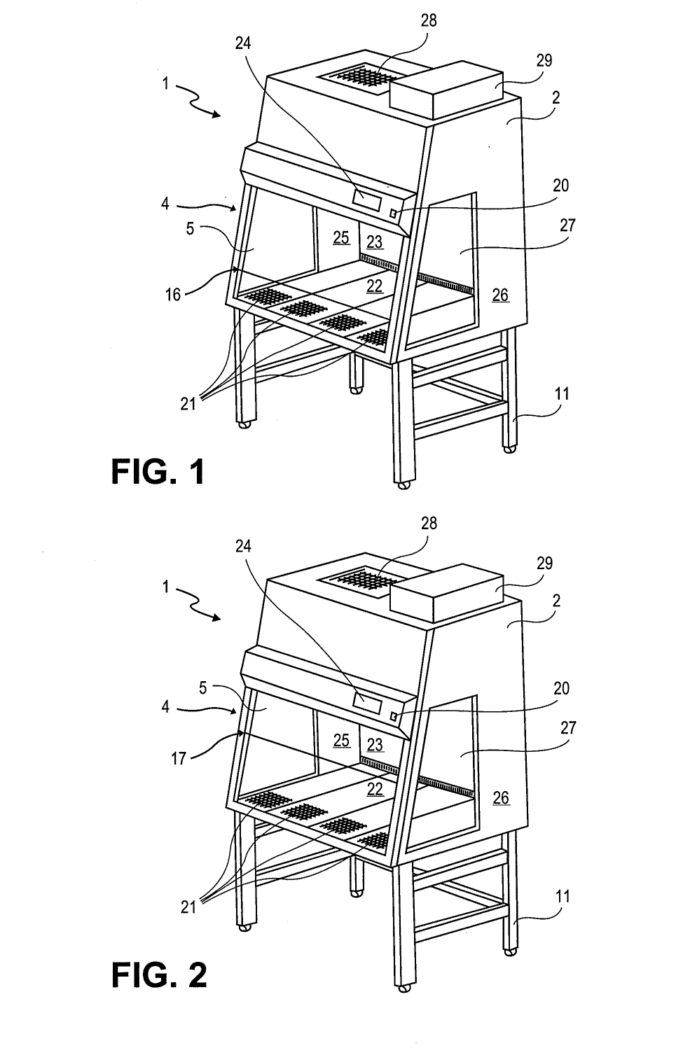

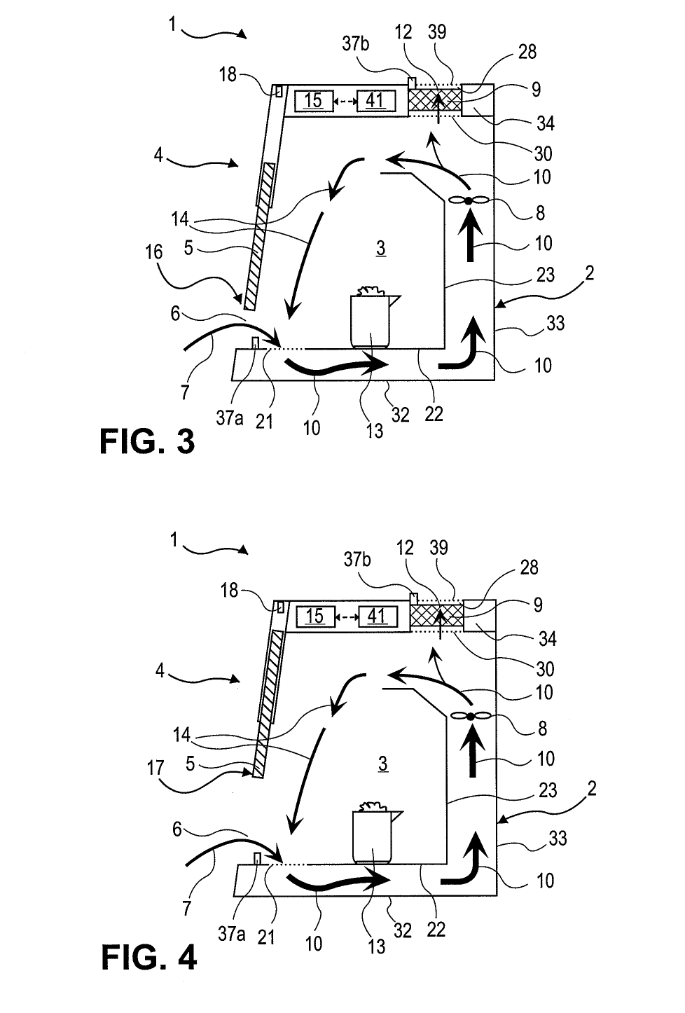

FIGS. 1 through 4 show a safety workbench 1 according to the present invention, which may be used for processing microbiological cultures, for example. In its basic construction, the safety workbench 1 corresponds to that known from the prior art. The safety workbench 1 has a housing 2, which encloses a work inner chamber 3 and is seated on a frame stand 11. The work inner chamber 3 is implemented to receive one or more sample containers 13, in which microbiological cultures are located. An adjustable front pane 5 is situated on the housing front side 4. The front pane 5 is mounted in such a way that it may be pushed up and down essentially parallel to the housing front side 4 between a first work position 16 (see FIGS. 1 and 3) and a second work position 17 (see FIGS. 2 and 4). Of course, the front pane 5 may also be brought into a closed position which cuts off the work inner chamber 3 from the ambient air.

The safety workbench 1 is set in such a way that the front pane 5 is adjustable between a total of three positions, the closed position, the first work position 16, and the second work position 17. The height of the work opening 6 results from the gap between the bottom side of the front pane 5 and the work chamber floor plate 22 of the housing 2. The height and thus also the area of the work opening 6 are less in the first work position 16 of the front pane 5 than in the second work position 17. If the front pane 5 is located in the second work position 17, the height of the work position 6 is great enough that an operator may place a sample container 13 in the work inner chamber 3 and/or remove it therefrom. If the front pane 5 is located in the first work position 16, in contrast, the height of the work opening 6 is significantly decreased, so that the sample container 13 may no longer be inserted and/or removed. However, enough space still remains in the first work position 16 so that an operator may reach into the work chamber 3 through the work opening 6 and perform work on the microbiological cultures located in the sample container 13. In the first work position 16, the control unit 15 and/or the regulating unit 41 reduce the delivery outputs of the fan 8 in relation to the second work position 17, so that a reduced noise level and a lower heat radiation of the safety workbench 1 result in the first work position 16, by which the working conditions are improved for operators.

The front pane 5 is moved between the individual positions by operating a rocker switch 20 attached to the housing front side 4, which is implemented as a double rocker. The rocker switch 7 thus has an upper and a lower rocker switch, the front pane 5 moving upward into a position by actuating the upper rocker switch (e.g., from the first work position 16 into the second work position 17) and correspondingly moving downward into a position by actuating the lower rocker switch (e.g., from the first work position 16 into the closed position). The safety workbench may be set up in such a way that other functions may also be triggered in addition to moving the front pane 5 by actuating the rocker switch 20. Thus, the rocker switch 20 may be configured in such a way, for example, that the power supply of the safety workbench 1 is turned on in addition to moving the front pane 5 from the closed position into the first work position 16 by actuating the upper rocker switch.

In addition to the rocker switch 20, a display 24, using which the operating state of the safety workbench 1 and/or error messages may be displayed to the user, is located on the housing front side 4.

The housing 2 is typically constructed from two shells, so that the housing itself is at least partially used as a ventilation duct for the air flows circulating in the safety workbench. Two side panes 27 are located on the sides 25, 26 of the housing. The side panes 27, like the front pane 25, comprise glass, e.g., suitable composite glass. Intake openings 21 are situated in the area of the work opening 6 in the work chamber floor plate 22. An external floor plate 32 runs outside and parallel to the work chamber floor plate 22. The intermediate space between these two plates 22, 32 forms a ventilation duct, through which an air flow 10 flows from the housing front side 4 in the direction toward the housing rear wall. In the further course of its flow, the air flow 10 is led upward through the intermediate space, also implemented as a ventilation duct, between inner rear wall 23 and outer rear wall 33. The fan 8, which sucks in the air flow 10, is located at the upper end of this ventilation duct. The thicknesses of the flow arrows 7, 10, 12, 14 in FIGS. 2 and 4 schematically illustrate the different volumes of the particular air flows.

A part of the air flow 10 sucked in by the fan 8 flows as exhaust air flow 12 through the exhaust air duct inlet 30 into the exhaust air duct 28, which is implemented as running through the upper cover 34. A filter 9 is situated in the interior of the exhaust air duct 28, through which the exhaust air flow 12 flows. The filter 9 is a typical HEPA filter, for example, which filters out contaminants such as microorganisms from the ambient air and thus prevents contaminants from being carried into the outside air with the exhaust air flow 12. A flow sensor 37b is situated directly behind the filter 9 in the flow direction to measure the exhaust air velocity. This sensor 37b transmits the values measured thereby to the regulating unit 41, so that this influencing variable may be compensated for. The exhaust air flow 12 may flow outward through the exhaust air duct outlet 39 in its further course and may be fed to the external air surrounding the safety workbench 1 or an exhaust air system which is part of the building (not shown in greater detail here). The majority of the air flow 10 is conducted by the fan 8 as the circulating air flow 14 unfiltered back into the work inner chamber 3. The exhaust air 12 filtered out of the safety workbench 1 is replaced by an external air flow 7 flowing through the work opening 6 into the work inner chamber 3. The external air flow 7 and the exhaust air flow 12 have approximately equal flow quantities, so that overall a constant air flow quantity is present in the safety workbench 1. The external air flow 7 is sucked in by the fan 8 and unified in the work inner chamber 3 with the ambient air flow 14 to form the air flow 10. The safety workbench 1 shown here thus exclusively provides personal protection and no product protection and is thus a safety workbench of class I.

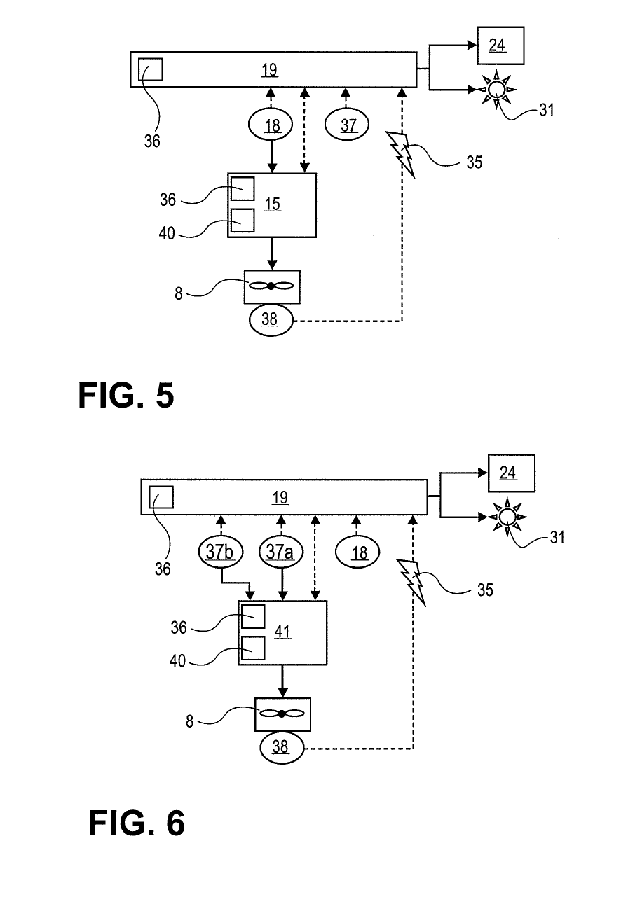

Referring to Figures, to be able to achieve an optimally adapted output of the fan 8 continuously, the position of the front pane 5 in the safety workbench 1 is monitored. For this reason, a position sensor 18 is situated in the area of the housing front side 4, which continuously ascertains the current front pane position and transmits the measured value to a control unit 15 (cf. FIG. 5). The control unit 15 is situated in the upper housing cover 34. Alternatively, situating it in the switch box 29 is also conceivable. Delivery output values of the fan 8 for every possible work position were stored in a storage medium 36, which is implemented as integrated in the control unit 15, before the safety workbench 1 was put into operation. Specifically, a delivery output value for the first work position 16 and a further delivery output value for the second work position 17 are thus stored in the storage medium 36 of the control unit 15. Furthermore, the control unit has a processor 40, using which the required computing operations are executable. The control unit 15 controls the power supply of the fan 8 in such a way that it delivers an air volume flow 10, whose dimension corresponds to the delivery output value of the particular existing work position. The delivery output values stored in the storage medium 36 of the control unit 15 are selected in such a way that the air entry velocity of the external air flow 7 in the area of the work opening 6 is approximately constant even at different work positions. The air entry velocity is also set in such a way that personal protection is ensured at all times.

Referring to FIG. 6, to take further influencing variables, which influence the air entry velocity, into consideration in addition to the work opening height, a regulating unit 41 is provided in addition to the control unit 15. Like the control unit 15, the regulating unit 41 is situated in the upper housing cover 34. Alternatively, situating it in the switch box 29 is also conceivable here. In the present example, the control unit 15 and the regulating unit 41 are implemented separately from one another, but communicate with one another (indicated by the dashed double arrow). Fundamentally, an integrated construction is also conceivable, however. A setpoint value or a setpoint value range for the exhaust air velocity were stored in a storage medium 36 (cf. FIG. 6), which is implemented as integrated in the regulating unit 41, before the safety workbench 1 was put into operation. The flow sensor 37b transmits the actual values of the exhaust air velocity to the regulating unit 41 at continuous intervals. If the actual value deviates from the setpoint value, for example, due to filter contamination, the regulating unit 41 adapts the delivery output of the fan 8 in such a way that both the air entry velocity and also the exhaust air velocity always lie in the predefined value ranges.

To ensure that the personal protection is not endangered by an operational malfunction of the safety workbench 1, a flow sensor 37a is situated in the area of the work opening 6, which measures the air entry velocity and delivers the measured values to the safety monitoring system 19. The flow sensor 37a is an anemometer, for example. The safety monitoring system 19 may be situated in the switch box 29, for example. In the present exemplary embodiment, the safety monitoring system 19 is implemented separately from the control unit 15 and the regulating unit 41. However, an integrated construction is also conceivable. The systems have a communication link to one another. A storage medium 36, in which a setpoint value range for the air entry velocity is stored, is also provided in the safety monitoring system 19. If a value of the air entry velocity measured by the flow sensor 37a lies outside the setpoint value range, the safety monitoring system 19 causes an alarm device 31 to output an acoustic and/or visual signal which informs the user that there is a malfunction. Furthermore, the safety monitoring system 19 transmits a corresponding signal to the display 24, which displays the precise error status to the user. In case of regulation alone (cf. FIG. 6), the flow sensor 37a additionally transmits the actual values of the air entry velocity to the regulating unit 41, which compares them to setpoint values stored in its storage medium 36 and regulates the delivery output of the fan 8 in such a way that the actual value is at least approximately equal to the setpoint value.

In addition to the flow sensor 37a, the safety monitoring system 19 monitors the control unit 15, the regulating unit 41, the position sensor 18, and a measuring device 38 for measuring the power consumption and/or the speed of the fan 8. The feedback belonging to the safety monitoring system 19 is shown as dashed arrows in FIGS. 5 and 6. If one of the components does not function properly, the safety monitoring system 19 also causes the output of an alarm signal by the alarm device 31 and/or the output of a corresponding message using the display 24. In addition, maximal and/or minimal values for the position sensor 18 and for the measuring device 38 are stored in the storage medium 36 of the safety monitoring system 19, which also cause an alarm and a corresponding message to be output if these values are exceeded or fallen below, respectively.

For example, there is a malfunction of the fan 8 in the schematic diagram shown in FIGS. 5 and 6. This error message is communicated by the measuring device 38 to the safety monitoring system 19, as schematically indicated by the arrow 35, which in turn activates an alarm device 31 and a display 34. The alarm device 31 is a light here. A visual alarm thus communicates to the user of the safety workbench 1 that there is a malfunction. Furthermore, it is specified to the user via the display 24 that it is a malfunction of the fan 8.

1. A safety workbench, comprising:
a work chamber enclosed by a housing including a work opening, located in the housing front side and settable using an adjustable front pane, to let in an external air flow flowing into the work chamber, and including at least one fan for delivering the external air flow into the safety workbench;
characterized in that a regulating unit or a control unit is provided, by which the delivery output of the at least one fan is regulated or controlled as a function of the front pane position.

2. The safety workbench according to claim 1, wherein the regulating unit or the control unit is implemented to regulate or control the at least one fan in such a way that the air entry velocity of the external air flow is essentially constant.

3. The safety workbench according to claim 1, wherein a flow sensor is situated in the area of the work opening for measuring the air entry velocity of the external air flow.

4. The safety workbench according to claim 1, wherein at least a part of the external air flow sucked in by the at least one fan is blown out of the safety workbench through an exhaust air filter as an exhaust air flow,
characterized in that a flow sensor is situated behind the exhaust air filter to measure the velocity of the exhaust air flow.

5. The safety workbench according to claim 3, further comprising
an air entry velocity setpoint value is stored in the regulating unit, and the regulating unit is implemented to regulate the delivery output of the at least one fan in such a way that the measured air entry velocity values essentially correspond to the air entry velocity setpoint value.

6. The safety workbench according to claim 4, further comprising
an exhaust air velocity setpoint value is stored in the regulating unit, and the regulating unit is implemented to regulate the delivery output of the at least one fan in such a way that the measured exhaust air velocity values essentially correspond to the exhaust air velocity setpoint value.

7. The safety workbench according to claim 1, further comprising
a position sensor is provided for measuring the position of the front pane.

8. The safety workbench according to claim 7, further comprised of previously determined delivery output values are stored in the control unit, each delivery output value is assigned to a front pane position, and the control unit is implemented to control the delivery output of the at least one fan in such a way that the delivery output essentially corresponds to the delivery output value assigned to the particular measured front pane position.

9. The safety workbench according to claim 7, further comprising a formula is stored in the control unit, using which a corresponding delivery output value may be ascertained for every front pane position, and the control unit is implemented to control the delivery output of the at least one fan in such a way that the delivery output essentially corresponds to the delivery output value ascertained for the particular measured front pane position.

10. The safety workbench according claim 5, wherein characterized in that the regulating unit or the control unit comprise at least one storage medium for storing the setpoint values or the delivery output values or the formula and at least one processor for analyzing the measured values transmitted thereto and for comparing them to the stored setpoint values or delivery output values or for calculating the delivery output values.

11. The safety workbench according to claim 10, further comprising a terminal and/or an interface, using which the values and/or the formula may be input into the at least one storage medium.

12. The safety workbench according claim 1, wherein the front pane is adjustable in steps, preferably between a first work position and a second work position.

13. The safety workbench according to claim 12, wherein the height of the work opening is in a range from 10 cm to 20 cm, preferably 13 cm to 17 cm in the first work position, and is in a range from 30 cm to 40 cm, preferably 33 cm to 37 cm in the second work position.

14. The safety workbench according to claim 12, wherein in the first work position, the mean noise level of the safety workbench during operation is in a range from 50 dB to 55 dB, preferably 52 dB to 53 dB.

15. The safety workbench according to claim 10, wherein different front pane positions are stored in the storage medium for different operating states of the safety workbench, between which the front pane is movable.

16. The safety workbench according to claim 7, wherein
it is implemented to output a visual and/or acoustic alarm if the measured height of the work opening exceeds a previously determined maximum value.

17. The safety workbench according to claim 1, further comprising at least one measuring device for determining the power consumption or the speed or both power consumption and speed of the at least one fan.

18. The safety workbench according to claim 1, further comprising characterized in that it has a safety monitoring system, which has at least one storage medium for storing setpoint value ranges and which, when it establishes a deviation
of the air entry velocity or
the exhaust air velocity or
the power consumption of the at least one fan or
the speed of the at least one fan
from a corresponding, stored setpoint value range, outputs a visual or acoustic alarm or both visual and acoustic alarm.

19. The safety workbench according to claim 18, further comprising:
a safety monitoring system for monitoring the functional capability of at least one of the following components:
position sensor
flow sensor
measuring device
fan
power supply of the safety workbench,
and the safety monitoring system is implemented to output a visual and/or acoustic alarm and/or, using a display, a corresponding error message in the event of a breakdown or a defect of at least one of the monitored components.

20. The safety workbench according to claim 12, wherein the height of the work opening is in range of 13 cm to 17 cm in the first work position, and is in a range from 33 cm to 37 cm in the second work position.
